(19) United States
(12) Patent Application Publication
(10) Pub. No.: US 2008/0121351 A1
(43) Pub. Date: May 29, 2008

(54) MOVABLE SEAT OF A VERTICAL CURTAIN

(76) Inventor: Ya-Ying Lin, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/563,887

(22) Filed: Nov. 28, 2006

(51) Int. Cl. E06B 9/38

(52) U.S. Cl. 160/177 V

(57) ABSTRACT

A movable seat of a vertical curtain is disposed in an upper rail and is provided for suspending vertical curtain blades. One side of the movable seat is defined with an open slot for engaging with a distance piece, and a hook hole is formed in a top end of the movable seat. A connecting post is locked in the hook hole for connecting to a scissor type distance piece. By such arrangements, plural movable seats can be moved interactively by choosing the distance piece or the scissor type distance piece, thus controlling the angle of the vertical curtain blades.

### BACKGROUND OF THE INVENTION

1. Field of the Invention

The present invention relates to a movable seat of a vertical curtain which is disposed in an upper rail and is provided for suspending the vertical curtain blades. One side of the movable seat is defined with an open slot for engaging with a distance piece, and a hook hole is formed in a top end of the movable seat. A connecting post is locked in the hook hole for connecting to a scissor type distance piece, enabling plural movable seats to move interactively, so as to control the angle of the vertical curtain blades. Thereby, the movable seat of the present invention can meet with the requirements of different structures with interactive moving effects.

2. Description of the Prior Art

A conventional vertical curtain generally comprises a plurality of vertical curtain blades suspended by movable seats disposed in an upper rail, such as the structure described in U.S. Pat. No. 6,866,078. However, the conventional invention cannot simplify the making process and the molds. A turning rod is inserted into a turning seat of each of the movable seats, in addition to that, there must be a linkage between the movable seats, such that the vertical curtain blades can be opened or closed by pulling an adjusting rod. Thereby, the main problem is the arrangements of distance pieces and scissor type distance pieces (the distance pieces are strip-shaped and can be passed through to each other, so the distances between the curtain blades are adjustable; and the scissor type distance pieces use the adjustable scissor type posts to change the distances of the curtain blades). Thereby, the shapes of the cross sections of the upper rail are different, such that the movable seats can be moved in the upper rail interactively.

Since the connecting structures of the distance piece and the scissor type distance piece to the movable seat are different (one is assembled to a side of the movable seat, and the other is assembled to a top end of the movable seat), the conventional invention is high cost (two kinds of movable seats must be manufactured to meet the users' requirement).

The present invention has arisen to mitigate and/or obviate the afore-described disadvantages.

### SUMMARY OF THE INVENTION

The primary objective of the present invention is to provide a movable seat of a vertical curtain which is disposed in an upper rail and is provided for suspending the vertical curtain blades. One side of the movable seat is defined with an open slot, and a hook hole is formed in a top end of the movable seat for insertion of a connecting post.

Since one side of the movable seat of the present invention is defined with an open slot, a distance piece can be disposed between two movable seats, such that the movable seats can be moved interactively. After the plural movable seats are disposed in the upper rail, each movable seat can position a vertical curtain blade. Furthermore, with regards to a scissor type distance piece, the scissor type distance piece can be passed through the hook hole of the top end of the movable seat by the connecting post directly, thereby, the movable seat is applicable to the distance piece and the scissor type distance piece, so as to reduce the cost.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a vertical curtain in accordance with the present invention;

FIG. 2 is a perspective view of a movable seat in accordance with the present invention;

FIG. 3 is a perspective view of the movable seat and a distance piece in accordance with the present invention;

FIG. 4 is a perspective view of showing the interactive moving of the movable seats via the distance pieces;

FIG. 5 is a perspective view of the movable seat connected to a connecting post;

FIG. 6 is a perspective view of showing the interactive moving of the movable seats via the scissor type distance pieces;

FIG. 7 is another perspective view of the movable seat connected to the connecting post;

FIG. 8 is a further perspective view of the movable seat connected to the connecting post; and

FIG. 9 is still a perspective view of the movable seat connected to the connecting post.

### DETAILED DESCRIPTION OF THE PREFERRED EMBODIMENTS

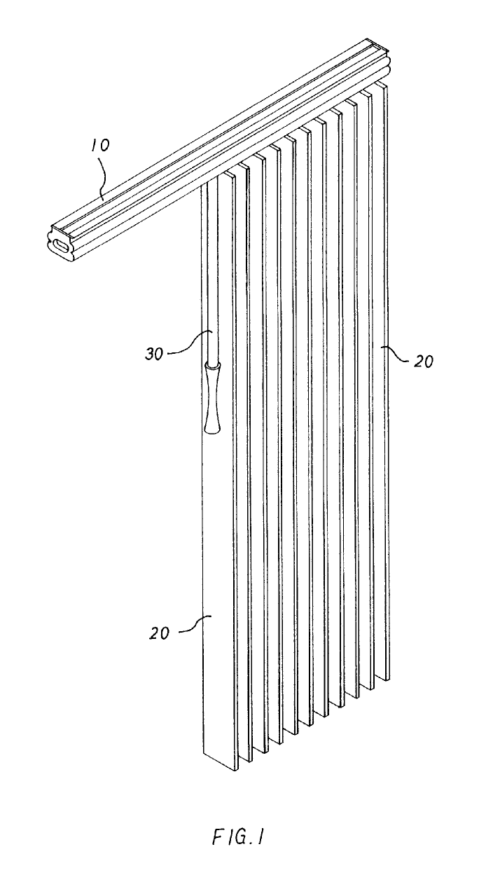

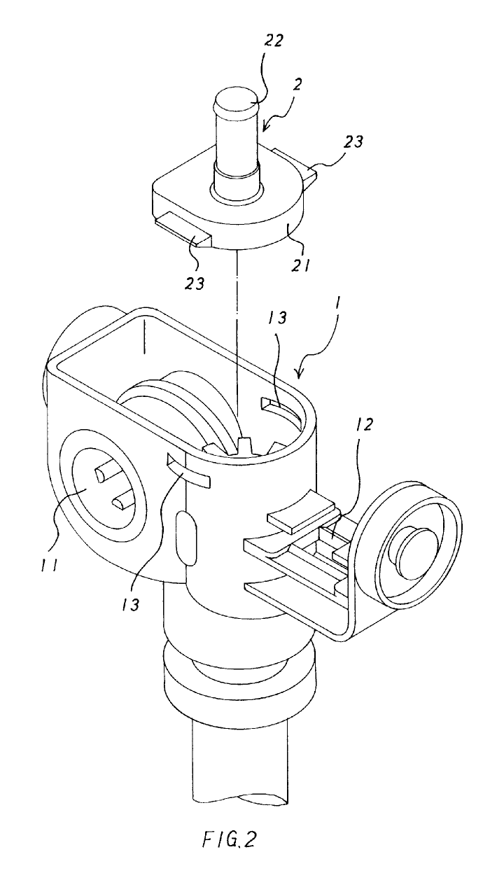

Referring to FIGS. 1 and 2, a movable seat 1 of a vertical curtain in accordance with the present invention is disposed in an upper rail 10 and is provided for suspending the vertical curtain blades 20.

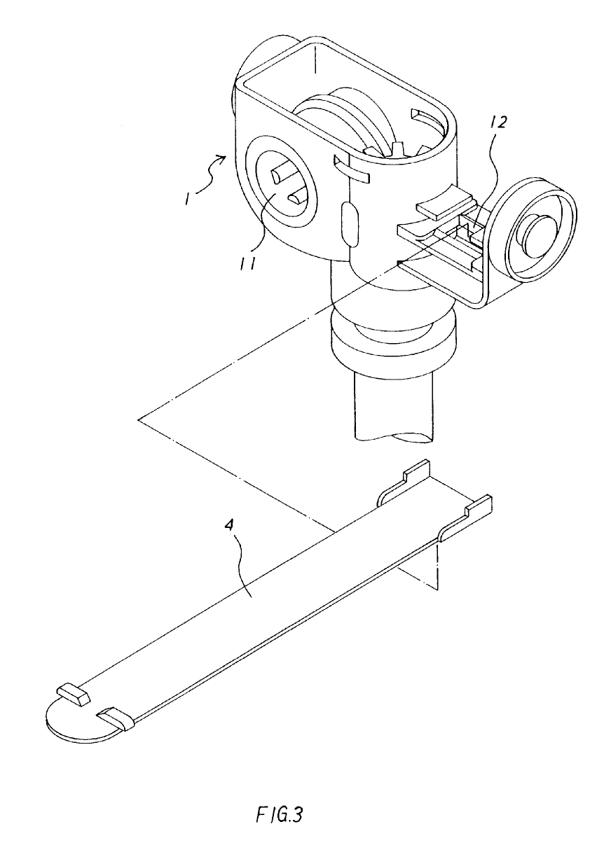

A turning seat 11 is disposed in the movable seat 1 for insertion of a turning rod 3, one side of the movable seat 1 is defined with an open slot 12 for engaging with a distance piece 4, and a hook hole 13 is formed in a top end of the movable seat 1 (as shown in FIG. 3).

A pivoting pole 22 is protruded out of a base 21 of a connecting post 2, and a locking hook 23 located correspondingly to the hook hole 13 is disposed on a side of the base 21.

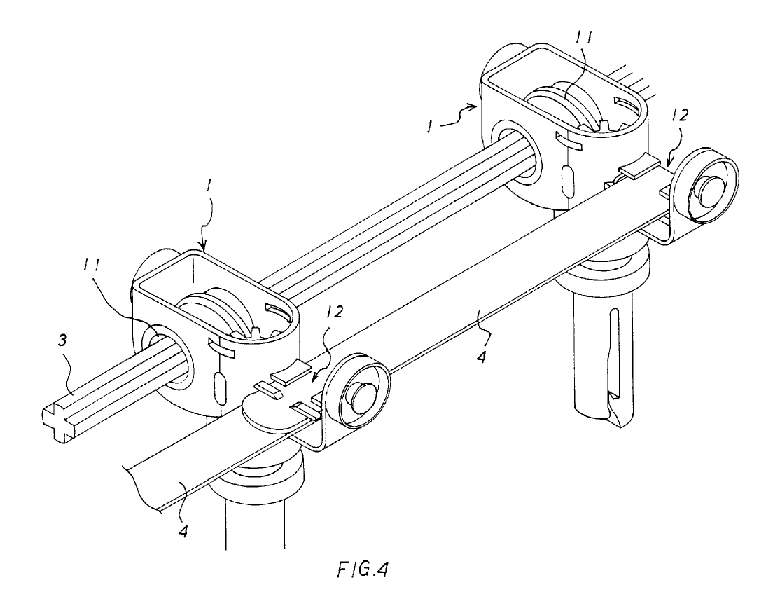

By such arrangements, the turning seats 11 of plural movable seats 1 are provided for insertion of the turning rods 3, and the open slot 12 of each movable seat 1 is provided for engaging with the corresponding distance piece 4. Since front and rear ends of each distance piece 4 can be connected to each other, the movable seats 1 have the characteristic of moving interactively (as shown in FIG. 4). Thereby, after the movable seats 1 are disposed in the upper rail 10, the respective movable seat 1 is provided for suspending the vertical curtain blade 20, thus finishing the assembly of the vertical curtain.

Therefore, in operation, the adjusting rod 30 can open or close the vertical curtain blades 20, or the angle of the vertical curtain blades 20 can be adjusted by rotating the turning rod 3 with the adjusting rod 30.

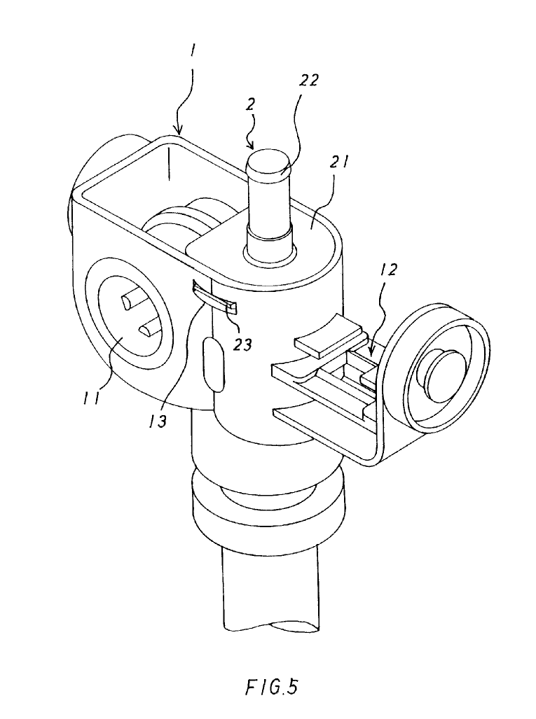

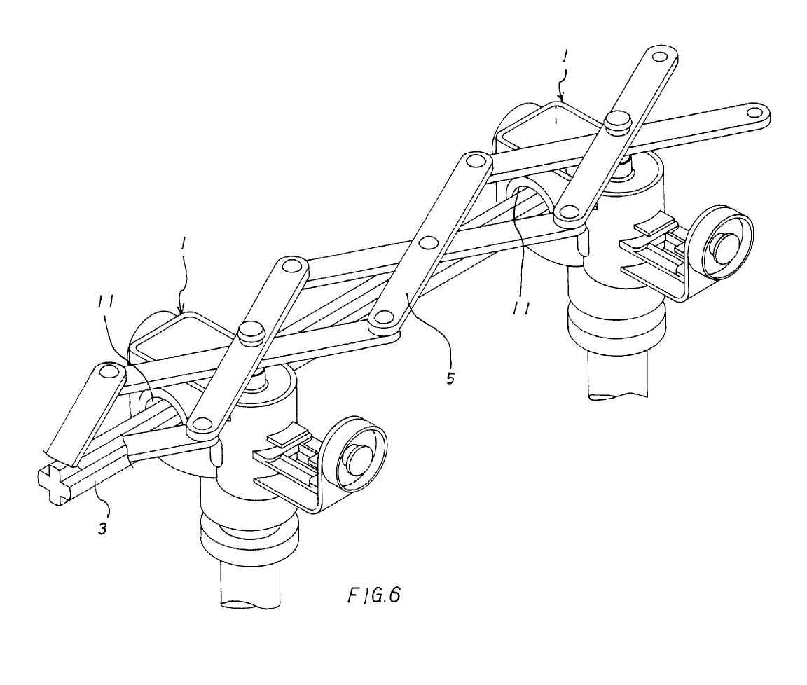

To assemble the scissor type distance pieces 5 to the movable seats 1, a top end of each movable seat 1 is firstly connected to the connecting post 2 (as shown in FIG. 5), and plus the connecting post 2 is connected to the scissor type distance pieces 5, the movable seats 1 can be moved interactively (as shown in FIG. 6). Thereby, the distance pieces 4 and the scissor type distance pieces 5 can be disposed on the movable seat 1 simultaneously, and one kind of movable seat 1 can be manufactured to meet with the requirements of different structures with interactive moving effects, so as to reduce the cost.

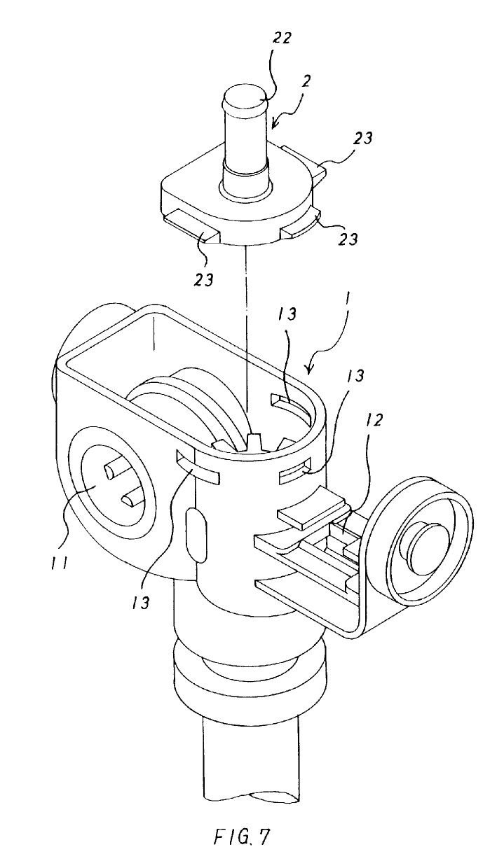

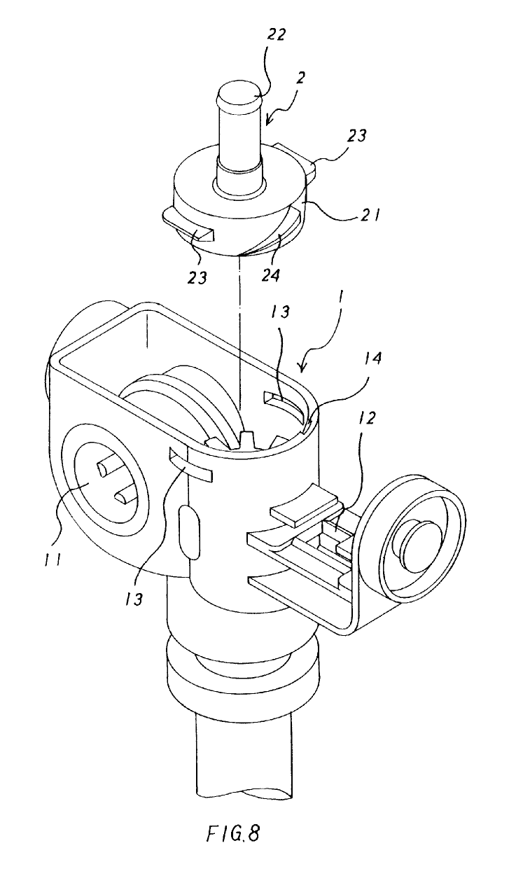

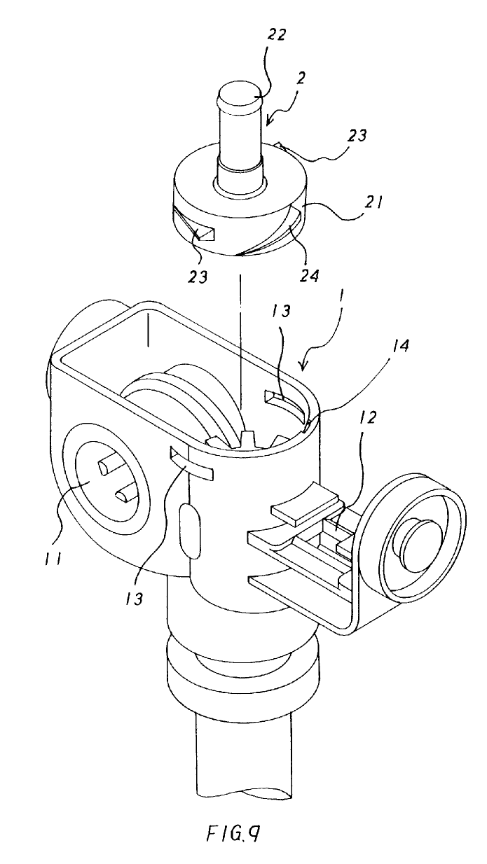

A plurality of locking hooks 23 of the connecting post 2 (as shown in FIG. 7) is locked in the hook holes 13 to improve the connection of the movable seat 1 and the connecting post 2. A threaded section 24 is protruded out of the base 21 of the connecting post 2 (as shown in FIG. 8), such that the movable seat 1 can be connected to the connecting post 2 stably. A threaded groove 14 is defined in the movable seat 1 and is located correspondingly to the threaded section 24, and the engaging of the threaded section 24 with the threaded groove 14 enables the locking hook 23 to lock in the hook hole 13 easily. In addition, the locking hook 23 can be inclined along the threaded direction (as shown in FIG. 9), thereby, the locking hook 23 can also be locked in the hook hole 13 easily.

While we have shown and described various embodiments in accordance with the present invention, it should be clear to those skilled in the art that further embodiments may be made without departing from the scope of the present invention.

What is claimed is:

1. A movable seat of a vertical curtain disposed in an upper rail and provided for suspending vertical curtain blades, wherein:
a turning seat is disposed in the movable seat for insertion of a turning rod, one side of the movable seat is defined with an open slot for engaging with a distance piece, and a hook hole is formed in a top end of the movable seat;
a pivoting pole is protruded out of a base of a connecting post for connecting to a scissor type distance piece, and a locking hook located correspondingly to the hook hole is disposed on a side of the base;
by such arrangements, the open slot of the movable seat is provided for connecting to the distance piece, and the connecting post is connected to the scissor type distance piece, thus finishing the assembly of the vertical curtain blades according to the requirements.

2. The movable seat of a vertical curtain as claimed in claim 1, wherein the connecting post is disposed with a plurality of locking hooks.

3. The movable seat of a vertical curtain as claimed in claim 1, wherein a threaded section is protruded out of the base of the connecting post, a threaded groove is defined in the movable seat and is located correspondingly to the threaded section, and the locking hook is allowed to be locked in the hook hole easily.

4. The movable seat of a vertical curtain as claimed in claim 1 or 2 or 3, wherein the locking hook is inclined, thereby, the locking hook is allowed to be locked in the hook hole easily.
